(19) United States
(12) Patent Application Publication
(10) Pub. No.: US 2002/0034393 A1
(43) Pub. Date: Mar. 21, 2002

(54) Vector

(76) Inventors: Kyriacos A. Mitrophanous, Oxford (GB); Mark Uden, London (GB); Jonathan Rohll, Reading (GB); Susan Mary Kingsman, Appleton (GB); Alan John Kingsman, Appleton (GB)

Correspondence Address: FROMMER LAWRENCE & HAUG LLP, 745 Fifth Avenue, New York, NY, 10151, US

(21) Appl. No.: 09/860,996

(22) Filed: May 18, 2001

Related U.S. Application Data
(63) Continuation-in-part of application No. PCT/GB99/03866, filed on Nov. 19, 1999.

(30) Foreign Application Priority Data
Nov. 20, 1998 (GB) 9825524.3

(51) Int. Cl. G03B 1/00

(52) U.S. Cl. 396/661

(57) ABSTRACT

A retroviral vector capable of delivering an NOI and comprising an exogenous second synthesis element.

The present invention relates to a plus-strand synthesis element, uses thereof and its incorporation in a vector.

In particular, the present invention relates to a novel retroviral vector that is capable of delivering a nucleotide sequence of interest (hereinafter abbreviated as “NOI”)—or even a plurality of NOIs—to one or more target sites.

In addition, the present invention relates to inter alia a novel retroviral vector useful in gene therapy.

Gene therapy may include any one or more of: the addition, the replacement, the deletion, the supplementation, the manipulation etc. of one or more nucleotide sequences in, for example, one or more targeted sites—such as targeted cells. If the targeted sites are targeted cells, then the cells may be part of a tissue or an organ. General teachings on gene therapy may be found in Molecular Biology (Ed Robert Meyers, Pub VCH, such as pages 556-558).

By way of further example, gene therapy can also provide a means by which any one or more of: a nucleotide sequence, such as a gene, can be applied to replace or supplement a defective gene; a pathogenic nucleotide sequence, such as a gene, or expression product thereof can be eliminated; a nucleotide sequence, such as a gene, or expression product thereof, can be added or introduced in order, for example, to create a more favourable phenotype; a nucleotide sequence, such as a gene, or expression product thereof can be added or introduced, for example, for selection purposes (i.e. to select transformed cells and the like over non-transformed cells); cells can be manipulated at the molecular level to treat, cure or prevent disease conditions—such as cancer (Schmidt-Wolf and Schmidt-Wolf, 1994, Annals of Hematology 69;273-279) or other disease conditions, such as immune, cardiovascular, neurological, inflammatory or infectious disorders; antigens can be manipulated and/or introduced to elicit an immune response, such as genetic vaccination.

In recent years, retroviruses have been proposed for use in gene therapy. Essentially, retroviruses are RNA viruses with a life cycle different to that of lytic viruses. In this regard, a retrovirus is an infectious entity that replicates through a DNA intermediate. When a retrovirus infects a cell, its genome is converted to a DNA form by a reverse transcriptase enzyme. The DNA copy serves as a template for the production of new RNA genomes and virally encoded proteins necessary for the assembly of infectious viral particles.

There are many retroviruses and examples include: murine leukemia virus (MLV), human immunodeficiency virus (HIV), equine infectious anaemia virus (EIAV), mouse mammary tumour virus (MMTV), Rous sarcoma virus (RSV), Fujinami sarcoma virus (FuSV), Moloney murine leukemia virus (Mo-MLV), FBR murine osteosarcoma virus (FBR MSV), Moloney murine sarcoma virus (Mo-MSV), Abelson murine leukemia virus (A-MLV), Avian myelocytomatosis virus-29 (MC29), and Avian erythroblastosis virus (AEV).

A detailed list of retroviruses may be found in Coffin et al (“Retroviruses” 1997 Cold Spring Harbour Laboratory Press Eds: T M Coffin, S M Hughes, H E Varmus pp 758-763).

Basically, the family Retroviridae can be subdivided into three subfamilies; the oncoviruses, the spumaviruses and lentiviurses. All members are positive sense RNA viruses that replicate via a DNA intermediate. This RNA to DNA conversion process is carried out by the protein products of the viral pol gene; namely RNA-dependent DNA-polymerase (reverse transcriptase) and RNase H. The efficiency of this process is dependent on sequence elements contained within the virus. Classically these include two direct repeats named R and the tRNA primer binding site (required for first strand synthesis) and the 3′ polypurine tract (3′ PPT) (required for second strand synthesis). More recently, other second strand synthesis elements have also been identified (thus far only in the lentiviruses); these include the central PPT (c-PPT), the central termination sequence (CTS) and the U-box (Llyinskii and Desrosiers 1998). For recent review on the function of these elements and the second-strand synthesis see Coffin et al 1997.

Over the past decade retroviruses from all three sub-families have been modified for use as gene expression vectors. Such modifications normally involve the deletion of essential viral genes/sequences and their replacement with foreign promoters and/or cDNA of choice. This replacement rather than addition of cDNA is essential for two reasons. First, viral genomes much larger than wild-type are not packaged and second, without essential genes such genomes are incapable of replication. The latter is important from a safety perspective. For the production of retroviral vectors containing such replication deficient genomes the deleted genes (normally gag, pol and env) must therefore be supplied in trans. This is normally achieved with the use of producer cells engineered to express these genes from non-viral expression vectors. These producer cells are capable of packaging vector genomes into retroviral particles and the resulting particles capable of only one round of infection provided the recipient cells do not contain a source of gag-pol and env eg., from helper virus. For recent review on construction of retroviral expression vectors see Coffin et al 1997.

For ease of understanding, simple, generic structures (not to scale) of the RNA and the DNA forms of the retroviral genome are presented below in which the elementary features of the LTRs and the relative positioning of gag, pol and env are indicated.

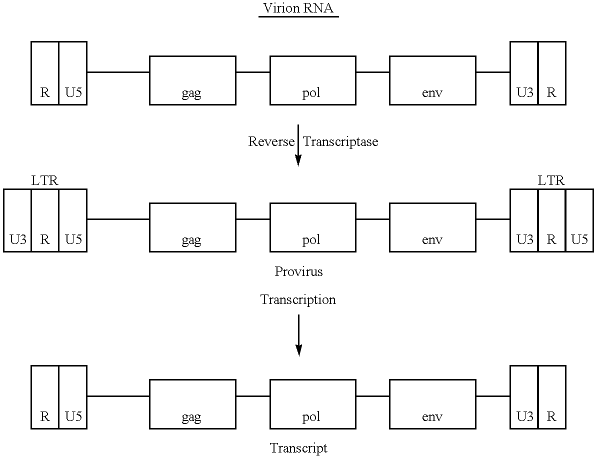

As shown in the diagram above, the basic molecular organisation of an infectious retroviral RNA genome is (5′) R-U5-gag, pol, env-U3-R (3′). In a defective retroviral vector genome gag, pol and env may be absent or not functional. The R regions at both ends of the RNA are repeated sequences. U5 and U3 represent unique sequences at the 5′ and 3′ ends of the RNA genome respectively.

Reverse transcription of the virion RNA into double stranded DNA takes place in the cytoplasm and involves two jumps of the reverse transcriptase from the 5′ terminus to the 3′ terminus of the template molecule. The result of these jumps is a duplication of sequences located at the 5′ and 3′ ends of the virion RNA. These sequences then occur fused in tandem on both ends of the viral DNA, forming the long terminal repeats (LTRs) which comprise R U5 and U3 regions. On completion of the reverse transcription, the viral DNA is translocated into the nucleus where the linear copy of the retroviral genome, called a preintegration complex (PIC), is randomly inserted into chromosomal DNA with the aid of the virion integrase to form a stable provirus. The number of possible sites of integration into the host cellular genome is very large and very widely distributed.

The control of proviral transcription remains largely with the noncoding sequences of the viral LTR. The site of transcription initiation is at the boundary between U3 and R in the left hand side LTR (as shown above) and the site of poly (A) addition (termination) is at the boundary between R and U5 in the right hand side LTR (as shown above). U3 contains most of the transcriptional control elements of the provirus, which include the promoter and multiple enhancer sequences responsive to cellular and in some cases, viral transcriptional activator proteins. Some retroviruses have any one or more of the following genes such as tat, rev, tax and rex that code for proteins that are involved in the regulation of gene expression.

Transcription of proviral DNA recreates the full length viral RNA genomic and subgenomic-sized RNA molecules that are generated by RNA processing. Typically, all RNA products serve as templates for the production of viral proteins. The expression of the RNA products is achieved by a combination of RNA transcript splicing and ribosomal framshifting during translation.

In addition to gag, pot and env, the complex retroviruses also contain “accessory” genes which code for accessory or auxiliary proteins. Accessory or auxiliary proteins are defined as those proteins encoded by the accessory genes in addition to those encoded by the usual replicative or structural genes, gag, pol and env. These accessory proteins are distinct from those involved in the regulation of gene expression, like those encoded by tat, rev, tax and rex. Examples of accessory genes include one or more of vif, vpr, vpx, vpu and nef. These accessory genes can be found in, for example, HIV (see, for example pages 802 and 803 of “Retroviruses” Ed. Coffin et al Pub CSHL 1997). Non-essential accessory proteins may function in specialised cell types, providing functions that are at least in part duplicative of a function provided by a cellular protein. Typically, the accessory genes are located between pol and env, just downstream from env including the U3 region of the LTR or overlapping portions of the env and each other.

It is conventional for second generation vectors to lack such accessory genes and also regions flanking, and which may include, the plus-strand synthesis elements.

The complex retroviruses have evolved regulatory mechanisms that employ virally encoded transcriptional activators as well as cellular transcriptional factors. These trans-acting viral proteins serve as activators of RNA transcription directed by the LTRs. The transcriptional trans-activators of the lentiviruses are encoded by the viral tat genes. Tat binds to a stable, stem-loop, RNA secondary structure, referred to as TAR, one function of which is to apparently optimally position Tat to trans-activate transcription.

As mentioned earlier, retroviruses have been proposed as a delivery system (otherwise expressed as a delivery vehicle or delivery vector) for inter alia the transfer of a NOI, or a plurality of NOIs, to one or more sites of interest. The transfer can occur in vitro, ex vivo, in vivo, or combinations thereof. When used in this fashion, the retroviruses are typically called retroviral vectors or recombinant retroviral vectors. Retroviral vectors have even been exploited to study various aspects of the retrovirus life cycle, including receptor usage, reverse transcription and RNA packaging (reviewed by Miller, 1992 Curr Top Microbiol Immunol 158:1-24).

In a typical recombinant retroviral vector for use in gene therapy, at least part of one or more of the gag, pol and env protein coding regions may be removed from the virus. This makes the retroviral vector replication-defective. The removed portions may even be replaced by a NOI in order to generate a virus capable of integrating its genome into a host genome but wherein the modified viral genome is unable to propagate itself due to a lack of structural proteins. When integrated in the host genome, expression of the NOI occurs—resulting in, for example, a therapeutic and/or a diagnostic effect. Thus, the transfer of a NOI into a site of interest is typically achieved by: integrating the NOI into the recombinant viral vector; packaging the modified viral vector into a virion coat; and allowing transduction of a site of interest—such as a targeted cell or a targeted cell population.

It is possible to propagate and isolate quantities of retroviral vectors (e.g. to prepare suitable titres of the retroviral vector) for subsequent transduction of, for example, a site of interest by using a combination of a packaging or helper cell line and a recombinant vector.

In some instances, propagation and isolation may entail isolation of the retroviral gag, pol and env genes and their separate introduction into a host cell to produce a “packaging cell line”. The packaging cell line produces the proteins required for packaging retroviral DNA but it cannot bring about encapsidation due to the lack of a psi region. However, when a recombinant vector carrying a NOI and a psi region is introduced into the packaging cell line, the helper proteins can package the psi-positive recombinant vector to produce the recombinant virus stock. This can be used to transduce cells to introduce the NOI into the genome of the cells. The recombinant virus whose genome lacks all genes required to make viral proteins can tranduce only once and cannot propagate. These viral vectors which are only capable of a single round of transduction of target cells are known as replication defective vectors. Hence, the NOI is introduced into the host/target cell genome without the generation of potentially harmful retrovirus. A summary of the available packaging lines is presented in “Retroviruses” (1997 Cold Spring Harbour Laboratory Press Eds: J M Coffin, S M Hughes, H E Varmus pp 449).

The design of retroviral packaging cell lines has evolved to address the problem of infer alia the spontaneous production of helper virus that was frequently encountered with early designs. As recombination is greatly facilitated by homology, reducing or eliminating homology between the genomes of the vector and the helper has reduced the problem of helper virus production. More recently, packaging cells have been developed in which the gag, pol and env viral coding regions are carried on separate expression plasmids that are independently transfected into a packaging cell line so that three recombinant events are required for wild type viral production. This reduces the potential for production of a replication-competent virus. This strategy is sometimes referred to as the three plasmid transfection method (Soneoka et al 1995 Nucl. Acids Res. 23: 628-633).

Transient transfection can also be used to measure vector production when vectors are being developed. In this regard, transient transfection avoids the longer time required to generate stable vector-producing cell lines and is used if the vector or retroviral packaging components are toxic to cells. Components typically used to generate retroviral vectors include a plasmid encoding the Gag/Pol proteins, a plasmid encoding the Env protein and a plasmid containing a NOI. Vector production involves transient transfection of one or more of these components into cells containing the other required components. If the vector encodes toxic genes or genes that interfere with the replication of the host cell, such as inhibitors of the cell cycle or genes that induce apotosis, it may be difficult to generate stable vector-producing cell lines, but transient transfection can be used to produce the vector before the cells die. Also, cell lines have been developed using transient infection that produce vector titre levels that are comparable to the levels obtained from stable vector-producing cell lines (Pear et al 1993, Proc Natl Acad Sci 90:8392-8396).

One of the challenges is to create high titre vectors for use in gene delivery. Some alternative approaches to developing high titre vectors for gene delivery have included the use of: (i) defective viral vectors such as adenoviruses, adeno-associated virus (AAV), herpes viruses, and pox viruses and (ii) modified retroviral vector designs.

We have now found it possible to improve vector function, and provide amongst other things a high titre vector.

According to a first aspect of the present invention there is provided a flanking polypurine tract (F-PPT) sequence or derivative, variant or homologue thereof.

We have identified this region and recognised that it may be useful for good vector function.

Examples of F-PPT sequences in accordance with the present invention include SEQ ID Nos: 1-7.

According to a second aspect of the present invention there is provided use of a retroviral plus-strand synthesis element for altering transduction ability of a retroviral vector or retroviral vector particle.

This ability may include enhancing transduction efficiency.

Examples of plus-strand synthesis elements for use in the present invention include PPT, including 3′PPT, c-PPT, CTS, U box, F-PPT and derivatives, variants and homologues thereof.

According to a third aspect of the present invention there is provided use of a retroviral plus-strand synthesis element for increasing the titre of a retroviral vector.

According to a fourth aspect of the present invention there is provided a retroviral vector in which one or more accessory genes are absent characterised in that it comprises a plus-strand synthesis element.

Preferably the vector is “retrovirus-based” meaning that the vector particles are derived from a retrovirus. The genome of the vector particle comprises components from the lentivirus as backbone. The vector particle as a whole contains essential vector components compatible with the RNA genome, including reverse transcription and integration systems. Usually these will include the gag and pol proteins derived from the retrovirus. Preferably the vector is capable of transducing a target cell. Usually it will include the env protein derived from the retrovirus. In a particularly preferred embodiment, the vector is “lentivirus-based”.

Preferably the vector is “minimal” in the sense that at least one of the genes vpr, vif vpu, tat, nef from the HIV-1 auxiliary genes or from the analogous auxiliary gene of other retroviruses are removed or disrupted. Preferably all are absent. Preferably rev or the analogous gene or a functionally analogous system thereof is present. More details on such a system can be found in our WO98/17815.

According to a fifth aspect of the present invention there is provided a retroviral vector capable of delivering an NOI and comprising an exogenous plus strand synthesis element.

Thus we have now found that plus-strand synthesis elements may be used to improve vector function over a vector lacking or having a wild type plus-strand synthesis element.

The fact that vector function is modified in some way can be determined by comparing function with and then without the plus-strand synthesis element used in accordance with the present invention. Such a determination is illustrated in the Examples below.

We have now found it possible to enhance vector production by, for example, at least 100 fold. This is surprising as at least one of the preferred plus strand synthesis elements of the present invention is conventionally removed in current vectors, together with the so-called accessory genes, as such minimal vectors were believed to provide advantages over the first generation vectors which conventionally contained such accessory features. Some of the plus strand synthesis elements which may be used in the present invention have previously been described; however, no one has previously realised that they can be used in developing improved vectors.

Reverse transcription begins when the viral particle enters the cytoplasm of a target cell. The viral RNA genome enters the cytoplasm as part of a nucleoprotein complex that has not been well characterized. The process of reverse transcription generates, in the cytoplasm, a linear DNA duplex via an intricate series of steps. This DNA is colinear with its RNA template, but it contains terminal duplications known as the long terminal repeats (LTRs) that are not present in viral RNA. Extant models for reverse transcription propose that two specialized template switches known as strand-transfer reactions or “jumps” are required to generate the LTRs.

Retroviral DNA synthesis is absolutely dependent on the two distinct enzymatic activities of RT: a DNA polymerase that can use either RNA or DNA as a template, and a nuclease, termed ribonuclease H (RNase H), that is specific for the RNA strand of RNA:DNA duplexes. Although a role for other proteins cannot be ruled out, and it is likely that certain viral proteins (e.g., nucleocapsid, NC) increase the efficiency of reverse transcription, all of the enzymatic functions required to complete the series of steps involved in the generation of a retroviral DNA can be attributed to either the DNA polymerase or the RNase H of RT. The process of retroviral DNA synthesis is believed to follow the scheme outlined below:

1 . Minus-strand DNA synthesis is initiated using the 3′ end of a partially unwound transfer RNA which is annealed to the primer-binding site (PBS) in genomic RNA, as a primer. Minus-strand DNA synthesis proceeds until the 5′ end of genomic RNA is reached, generating a DNA intermediate of discrete length termed minus-strand strong-stop DNA (−sssDNA). Since the binding site for the tRNA primer is near the 5′ end of viral RNA, −sssDNA is relatively short, on the order of 100-150 bases.

2. Following RNase-H-mediated degradation of the RNA strand of the RNA:−sssDNA duplex, the first strand transfer causes −sssDNA to be annealed to the 3′ end of a viral genomic RNA. This transfer is mediated by identical sequences known as the repeated (R) sequences, which are present at the 5′ and 3′ ends of the RNA genome. The 3′ end of −sssDNA was copied from the R sequences at the 5′ end of the viral genome and therefore contains sequences complementary to R. After the RNA template has been removed, −sssDNA can anneal to the R sequences at the 3′ end of the RNA genome. The annealing reaction appears to be facilitated by the NC

3. Once the −sssDNA has been transferred to the 3′ R segment on viral RNA, minus-strand DNA synthesis resumes, accompanied by RNase H digestion of the template strand. This degradation is not complete, however.

4. The RNA genome contains a short polypurine tract (PPT) that is relatively resistant to RNase H degradation. A defined RNA segment derived from the PPT primes plus-strand DNA synthesis. Plus-strand synthesis is halted after a portion of the primer tRNA is reverse-transcribed, yielding a DNA called plus-strand strong-stop DNA (+sssDNA). Although all strains of retroviruses generate a defined plus-strand primer from the PPT, some viruses generate additional plus-strand primers from the RNA genome.

5. RNase H removes the primer tRNA, exposing sequences in +sssDNA that are complementary to sequences at or near the 3′ end of plus-strand DNA.

6. Annealing of the complementary PBS segments in +sssDNA and minus-strand DNA constitutes the second strand transfer.

7. Plus- and minus-strand syntheses are then completed, with the plus and minus strands of DNA each serving as a template for the other strand.

By plus strand synthesis element we mean viral RNA that contributes to plus-strand DNA synthesis.

Plus-strand is sometimes referred to as second strand, and the notation for plus-strand DNA is +sssDNA. It will be appreciated that the invention also includes such elements also known as cis acting elements.

The RNA that contributes to plus-strand synthesis may be one from which a primer for plus-strand DNA synthesis is derived, or may be associated with such RNA. Preferably the RNA is resistant to RNase degradation. Alternatively the plus-strand synthesis element may be a cis-active terminator sequence, i.e. one which is involved in effective plus-strand synthesis.

Preferably the RNA is one from which a primer for second strand DNA synthesis is derived. In this regard in one embodiment the RNA is a region known as a polypurine tract (PPT), whose name reflects its base composition. Although the base composition is conserved, PPT sequences vary from virus to virus and this are all included in the present invention.

Some retroviruses—notably HIV and the ALVs—also use additional internal plus-strand primers which also derive from the viral RNA. The RNA from which such internal primers may be derived is also within the scope of the present invention.

Examples of such internal primers include the central PPT (c-PPT), the central termination sequence (CTS) and the U-box.

It will be appreciated that the vector of the present invention may comprise more than one exogenous plus-strand synthesis element. In this case the synthesis element may be the same or different.

By exogenous we include a retrovirus with a modified or additional plus-strand synthesis element. We also include replacement of the wild type plus strand synthesis element. The plus-strand synthesis element may be derived from the provirus uppon which the vector is based, from any other retrovirus, of artifical design, selected from by viral serial passage evolution or by random mutagenesis studies. Thus, the present invention also includes derivatives of such elements. The present invention also includes variants and homologues of such elements.

The terms “variant”, “homologue” or “derivative” in relation to the nucleotide sequence of the present invention include any substitution of, variation of, modification of, replacement of, deletion of or addition of one (or more) nucleic acid from or to the sequence providing the resultant nucleotide sequence has the activity of a plus-strand synthesis sequence, preferably having at least the same activity as one of the sequences presented in SEQ ID NOS: 1-18.

With respect to sequence homology, preferably there is at least 75%, more preferably at least 85%, more preferably at least 90% homology to the sequences shown in the sequence listing herein. More preferably there is at least 95%, more preferably at least 98%, homology. Nucleotide homology comparisons may be conducted as described above. A preferred sequence comparison program is the GCG Wisconsin Bestfit program described above. The default scoring matrix has a match value of 10 for each identical nucleotide and −9 for each mismatch. The default gap creation penalty is −50 and the default gap extension penalty is −3 for each nucleotide.

The present invention also encompasses nucleotide sequences that are capable of hybridising to the sequences presented herein, or any variant, fragment or derivative thereof, or to the complement of any of the above.

The term “hybridization” as used herein shall include “the process by which a strand of nucleic acid joins with a complementary strand through base pairing” as well as the process of amplification as carried out in polymerase chain reaction technologies.

Polynucleotides of the invention capable of hybridising to the nucleotide sequences presented herein, or to their complement, will be generally at least 70%, preferably at least 80 or 90% and more preferably at least 95% or 98% homologous to the corresponding nucleotide sequences presented herein.

Hybridization conditions are based on the melting temperature (Tm) of the nucleic acid binding complex, as taught in Berger and Kimmel (1987, Guide to Molecular Cloning Techniques, Methods in Enzymology, Vol 152, Academic Press, San Diego Calif.), and confer a defined “stringency” as explained below.

Maximum stringency typically occurs at about Tm-5° C. (5° C. below the Tm of the probe); high stringency at about 5° C. to 10° C. below Tm; intermediate stringency at about 10° C. to 20° C. below Tm; and low stringency at about 20° C. to 25° C. below Tm. As will be understood by those of skill in the art, a maximum stringency hybridization can be used to identify or detect identical polynucleotide sequences while an intermediate (or low) stringency hybridization can be used to identify or detect similar or related polynucleotide sequences.

In a preferred aspect, the present invention covers nucleotide sequences that can hybridise to the nucleotide sequence of the present invention under stringent conditions (e.g. 65° C. and 0.1× SSC {1× SSC =0.15 M NaCl, 0.015 M Na₃ Citrate pH 7.0).

Polynucleotides which are not 100% homologous to the sequences of the present invention but fall within the scope of the invention can be obtained in a number of ways. Other variants of the sequences described herein may be obtained for example by probing DNA libraries. In addition, other viral homologues particularly homologues found in e.g. rat, mouse, bovine and primate, may be obtained and such homologues and fragments thereof in general will be capable of selectively hybridising to the sequences shown in the sequence listing herein. Such sequences may be obtained by probing cDNA or genomic DNA libraries, and probing such libraries with probes comprising all or part of SEQ I.D. Nos 1-18 under conditions of medium to high stringency. Similar considerations apply to obtaining species homologues and allelic variants of nucleotide sequences of the invention.

Variants and strain/species homologues may also be obtained using degenerate PCR which will use primers designed to target sequences within the variants and homologues encoding conserved amino acid sequences within the sequences of the present invention Conserved sequences can be predicted, for example, by aligning the amino acid sequences from several variants/homologues. Sequence alignments can be performed using computer software known in the art. For example the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterised sequences, such as SEQ ID. Nos 1-18.

Polynucleotides of the invention may be used to produce a primer, e.g. a PCR primer, a primer for an alternative amplification reaction, a probe e.g. labelled with a revealing label by conventional means using radioactive or non-radioactive labels.

Nucleic acid sequences and probes according to the invention may be produced recombinantly, synthetically, or by any means available to those of skill in the art. They may also be cloned by standard techniques.

In general, primers will be produced by synthetic means, involving a step wise manufacture of the desired nucleic acid sequence one nucleotide at a time. Techniques for accomplishing this using automated techniques are readily available in the art.

Longer polynucleotides will generally be produced using recombinant means, for example using a PCR (polymerase chain reaction) cloning techniques.

The fact that such a derivative or synthetic element is still a plus-strand synthesis element may be tested using, for example according to the method of Example 1.

In one embodiment, the synthesis element is a region which flanks RNA from which a plus-strand primer is derived. The present invention also encompasses second strand sequences which become available.

An example of an especially preferred plus-strand synthesis element is a functional region in retroviral expression vectors that flank the 3′PPT. We have termed such regions the flanking PPT (F-PPT). Such regions have been previously been unrecognised as functional regions in retroviral expression.

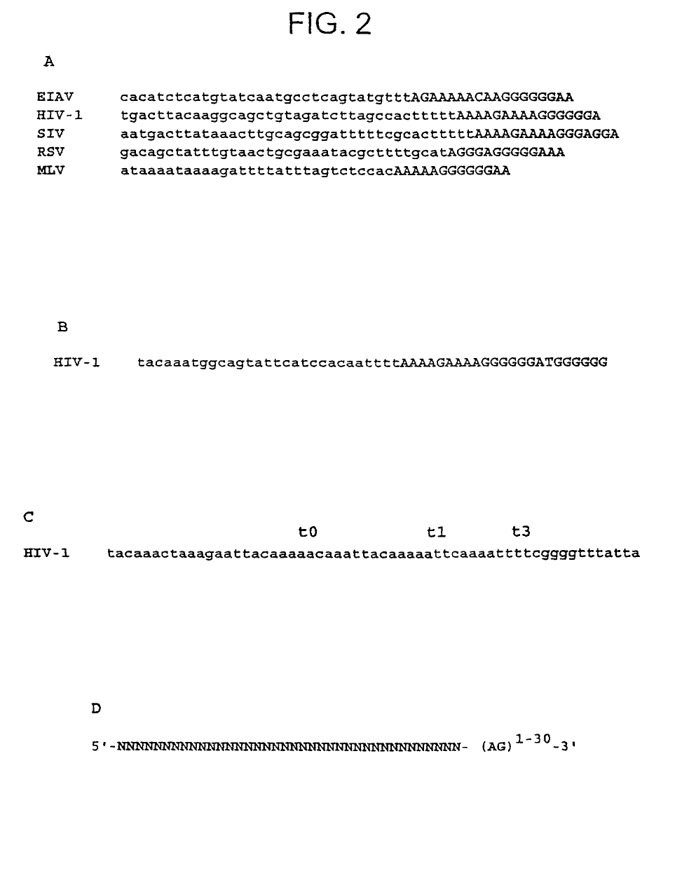

Examples of such F-PPT are shown in FIG. 2 and SEQ ID Nos 1-7.

Whilst not wishing to be bound by any theory based on our invention that plus-strand synthesis is important for optimal vector function, such synthesis may also be enhanced by modification of the trans acting proteins that interact with any of the cis acting elements required for second strand synthesis.

Thus, according to a sixth aspect of the present invention there is provided a retroviral vector packaging cell or cell line, or a retroviral vector expression plasmid or cassette comprising an exogenous trans acting element.

Preferably this element is pol.

Again by exogenous we include modified or additional trans acting elements. We also include replacement of the wild type trans acting element. The trans acting element may be derived from the provirus uppon which the vector is based, from any other retrovirus, of artifical design, selected from by viral serial passage evolution or by random mutagenesis studies. Thus, the present invention also includes derivatives of such elements. Derivatives of such elements may be obtained, for example, by mutagenesis.

The vector of the present invention is typically defective in that it is incapable of independent replication. Thus once the first viral vector component has transduced a first target cell, it is incapable of spreading by replication to any further target cells. Also when the second viral vector component is acting as a vector for the NOI, once the second viral vector component has transduced a secondary target cell, it is incapable of spreading by replication to any further target cells. Ways to achieve replication defective retroviral vectors are known in the art. For example, in the present case, reducing homology between the LTR's of the second viral vector component also has the effect of reducing the possibility of genetic recombination to produce an infectious virus capable of independent replication.

In one preferred aspect, the retroviral vector of the present invention has been pseudotyped. In this regard, pseudotyping can confer one or more advantages. For example, with the lentiviral vectors, the env gene product of the HIV based vectors would restrict these vectors to infecting only cells that express a protein called CD4. But if the env gene in these vectors has been substituted with env sequences from other RNA viruses, then they may have a broader infectious spectrum (Verma and Somia 1997 Nature 389:239-242). By way of example, workers have pseudotyped an HIV based vector with the glycoprotein from VSV (Verma and Somia 1997 ibid). Alternatively, env can be modified so as to affect (such as to alter) its specificity.

In another alternative, the Env protein may be a modified Env protein such as a mutant or engineered Env protein. Modifications may be made or selected to introduce targeting ability or to reduce toxicity or for another purpose.

Suitable NOI coding sequences include those that are of therapeutic and/or diagnostic application such as, but are not limited to: sequences encoding cytokines, chemokines, hormones, antibodies, engineered immunoglobulin-like molecules, a single chain antibody, fusion proteins, enzymes, immune co-stimulatory molecules, immunomodulatory molecules, anti-sense RNA, a transdominant negative mutant of a target protein, a toxin, a conditional toxin, an antigen, a tumour suppressor protein and growth factors, membrane proteins, vasoactive proteins and peptides, anti-viral proteins and ribozymes, and derivatives therof (such as with an associated reporter group). When included, such coding sequences may be typically operatively linked to a suitable promoter, which may be a promoter driving expression of a ribozyme(s), or a different promoter or promoters.

The NOI coding sequence may encode a fusion protein or a segment of a coding sequence

The retroviral vector of the present invention may be used to deliver a NOI such as a pro-drug activating enzyme to a tumour site for the treatment of a cancer. In each case, a suitable pro-drug is used in the treatment of the individual (such as a patient) in combination with the appropriate pro-drug activating enzyme. An appropriate pro-drug is administered in conjunction with the vector. Examples of pro-drugs include: etoposide phosphate (with alkaline phosphatase, Senter et al 1988 Proc Natl Acad Sci 85: 48424846); 5-fluorocytosine (with cytosine deaminase, Mullen et al 1994 Cancer Res 54: 1503-1506); Doxorubicin-N-p-hydroxyphenoxyacetamide (with Penicillin-V-Amidase, Kerr et al 1990 Cancer Immunol Immunother 31: 202-206); Para-N-bis(2-chloroethyl) aminobenzoyl glutamate (with carboxypeptidase G2); Cephalosporin nitrogen mustard carbamates (with β-lactamase); SR4233 (with P450 Reducase); Ganciclovir (with HSV thymidine kinase, Borrelli et al 1988 Proc Natl Acad Sci 85: 7572-7576); mustard pro-drugs with nitroreductase (Friedlos et al 1997 J Med Chem 40: 1270-1275) and Cyclophosphamide (with P450 Chen et al 1996 Cancer Res 56: 1331-1340).

The retroviral vector, plus strand synthesis element and trans acting element of the present invention may be obtainable from any known or discovered retrovirus. For ease of reference the classification of retroviruses is shown in Table 1; Table 2 shows principal retroviruses and their origins; and Table 3 lists the principal lentiviruses. These Tables may be found in Coffin J M et al ibid.

Preferably the vector is obtainable from a lentivirus genome.

The vector may be targetted, that is has a tissue tropism which is altered compared to the native virus, so that the vector is targeted to particular cells.

According to a seventh aspect of the present invention there is provided a retroviral production system for producing the retroviral vector of the present invention comprising a nucleic acid sequence encoding for the retroviral vector.

According to a eighth aspect of the present invention there is provided a retroviral vector produced by the production system of the present invention.

According to a ninth aspect of the present invention there is provided a retroviral particle obtainable from the retroviral vector of the present invention.

The term “retroviral vector particle” refers to the packaged retroviral vector, that is preferably capable of binding to and entering target cells. The components of the particle, as already discussed for the vector, may be modified with respect to the wild type retrovirus. For example, the Env proteins in the proteinaceous coat of the particle may be genetically modified in order to alter their targeting specificity or achieve some other desired function.

According to a tenth aspect of the present invention there is provided a cell transfected or transduced with a retroviral vector of the present invention.

According to an eleventh aspect of the present invention there is provided a retroviral vector, or retroviral particle, or cell in according with the present invention for use in medicine.

The delivery of one or more one or more therapeutic genes by a vector system according to the present invention may be used alone or in combination with other treatments or components of the treatment.

For example, the retroviral vector of the present invention may be used to deliver one or more NOI(s) useful in the treatment of the disorders listed in WO-A-98/05635. For ease of reference, part of that list is now provided: cancer, inflammation or inflammatory disease, dermatological disorders, fever, cardiovascular effects, haemorrhage, coagulation and acute phase response, cachexia, anorexia, acute infection, HIV infection, shock states, graft-versus-host reactions, autoimmune disease, reperfusion injury, meningitis, migraine and aspirin-dependent anti-thrombosis; tumour growth, invasion and spread, angiogenesis, metastases, malignant, ascites and malignant pleural effusion; cerebral ischaemia, ischaemic heart disease, osteoarthritis, rheumatoid arthritis, osteoporosis, asthma, multiple sclerosis, neurodegeneration, Alzheimer's disease, atherosclerosis, stroke, vasculitis, Crohn's disease and ulcerative colitis; periodontitis, gingivitis; psoriasis, atopic dermatitis, chronic ulcers, epidermolysis bullosa; corneal ulceration, retinopathy and surgical wound healing; rhinitis, allergic conjunctivitis, eczema, anaphylaxis; restenosis, congestive heart failure, endometriosis, atherosclerosis or endoscierosis.

In addition, or in the alternative, the retroviral vector of the present invention may be used to deliver one or more NOI(s) useful in the treatment of disorders listed in WO-A-98/07859. For ease of reference, part of that list is now provided: cytokine and cell proliferation/differentiation activity; immunosuppressant or immunostimulant activity (e.g. for treating immune deficiency, including infection with human immune deficiency virus; regulation of lymphocyte growth; treating cancer and many autoimmune diseases, and to prevent transplant rejection or induce tumour immunity); regulation of haematopoiesis, e.g. treatment of myeloid or lymphoid diseases; promoting growth of bone, cartilage, tendon, ligament and nerve tissue, e.g. for healing wounds, treatment of burns, ulcers and periodontal disease and neurodegeneration; inhibition or activation of follicle-stimulating hormone (modulation of fertility); chemotactic/chemokinetic activity (e.g. for mobilising specific cell types to sites of injury or infection); haemostatic and thrombolytic activity (e.g. for treating haemophilia and stroke); antiinflammatory activity (for treating e.g. septic shock or Crohn's disease); as antimicrobials; modulators of e.g. metabolism or behaviour; as analgesics; treating specific deficiency disorders; in treatment of e.g. psoriasis, in human or veterinary medicine.

In addition, or in the alternative, the retroviral vector of the present invention may be used to deliver one or more NOI(s) useful in the treatment of disorders listed in WO-A-98/09985. For ease of reference, part of that list is now provided: macrophage inhibitory and/or T cell inhibitory activity and thus, anti-inflammatory activity; anti-immune activity, i.e. inhibitory effects against a cellular and/or humoral immune response, including a response not associated with inflammation; inhibit the ability of macrophages and T cells to adhere to extracellular matrix components and fibronectin, as well as up-regulated fas receptor expression in T cells; inhibit unwanted immune reaction and inflammation including arthritis, including rheumatoid arthritis, inflammation associated with hypersensitivity, allergic reactions, asthma, systemic lupus erythematosus, collagen diseases and other autoimmune diseases, inflammation associated with atherosclerosis, arteriosclerosis, atherosclerotic heart disease, reperfusion injury, cardiac arrest, myocardial infarction, vascular inflammatory disorders, respiratory distress syndrome or other cardiopulmonary diseases, inflammation associated with peptic ulcer, ulcerative colitis and other diseases of the gastrointestinal tract, hepatic fibrosis, liver cirrhosis or other hepatic diseases, thyroiditis or other glandular diseases, glomerulonephritis or other renal and urologic diseases, otitis or other oto-rhino-laryngological diseases, dermatitis or other dermal diseases, periodontal diseases or other dental diseases, orchitis or epididimo-orchitis, infertility, orchidal trauma or other immune-related testicular diseases, placental dysfunction, placental insufficiency, habitual abortion, eclampsia, pre-eclampsia and other immune and/or inflammatory-related gynaecological diseases, posterior uveitis, intermediate uveitis, anterior uveitis, conjunctivitis, chorioretinitis, uveoretinitis, optic neuritis, intraocular inflammation, e.g. retinitis or cystoid macular oedema, sympathetic ophthalmia, scleritis, retinitis pigmentosa, immune and inflammatory components of degenerative fondus disease, inflammatory components of ocular trauma, ocular inflammation caused by infection, proliferative vitreo-retinopathies, acute ischaemic optic neuropathy, excessive scarring, e.g. following glaucoma filtration operation, immune and/or inflammation reaction against ocular implants and other immune and inflammatory-related ophthalmic diseases, inflammation associated with autoimmune diseases or conditions or disorders where, both in the central nervous system (CNS) or in any other organ, immune and/or inflammation suppression would be beneficial, Parkinson's disease, complication and/or side effects from treatment of Parkinson's disease, AIDS-related dementia complex HIV-related encephalopathy, Devic's disease, Sydenham chorea, Alzheimer's disease and other degenerative diseases, conditions or disorders of the CNS, inflammatory components of stokes, post-polio syndrome, immune and inflammatory components of psychiatric disorders, myelitis, encephalitis, subacute sclerosing pan-encephalitis, encephalomyelitis, acute neuropathy, subacute neuropathy, chronic neuropathy, Guillaim-Barre syndrome, Sydenham chora, myasthenia gravis, pseudo-tumour cerebri, Down's Syndrome, Huntington's disease, amyotrophic lateral sclerosis, inflammatory components of CNS compression or CNS trauma or infections of the CNS, inflammatory components of muscular atrophies and dystrophies, and immune and inflammatory related diseases, conditions or disorders of the central and peripheral nervous systems, post-traumatic inflammation, septic shock, infectious diseases, inflammatory complications or side effects of surgery, bone marrow transplanTation or other transplantation complications and/or side effects, inflammatory and/or immune complications and side effects of gene therapy, e.g. due to infection with a viral carrier, or inflammation associated with AIDS, to suppress or inhibit a humoral and/or cellular immune response, to treat or ameliorate monocyte or leukocyte proliferative diseases, e.g. leukaemia, by reducing the amount of monocytes or lymphocytes, for the prevention and/or treatment of graft rejection in cases of transplantation of natural or artificial cells, tissue and organs such as cornea, bone marrow, organs, lenses, pacemakers, natural or artificial skin tissue.

The present invention also provides a pharmaceutical composition for treating an individual by gene therapy, wherein the composition comprises a therapeutically effective amount of the retroviral vector of the present invention comprising one or more deliverable therapeutic and/or diagnostic NOI(s) or a viral particle produced by or obtained from same. The pharmaceutical composition may be for human or animal usage. Typically, a physician will determine the actual dosage which will be most suitable for an individual subject and it will vary with the age, weight and response of the particular individual.

The composition may optionally comprise a pharmaceutically acceptable carrier, diluent, excipient or adjuvant. The choice of pharmaceutical carrier, excipient or diluent can be selected with regard to the intended route of administration and standard pharmaceutical practice. The pharmaceutical compositions may comprise as—or in addition to—the carrier, excipient or diluent any suitable binder(s), lubricant(s), suspending agent(s), coating agent(s), solubilising agent(s), and other carrier agents that may aid or increase the viral entry into the target site (such as for example a lipid delivery system).

Where appropriate, the pharmaceutical compositions can be administered by any one or more of: inhalation, in the form of a suppository or pessary, topically in the form of a lotion, solution, cream, ointment or dusting powder, by use of a skin patch, orally in the form of tablets containing excipients such as starch or lactose, or in capsules or ovules either alone or in admixture with excipients, or in the form of elixirs, solutions or suspensions containing flavouring or colouring agents, or they can be injected parenterally, for example intracavernosally, intravenously, intramuscularly or subcutaneously. For parenteral administration, the compositions may be best used in the form of a sterile aqueous solution which may contain other substances, for example enough salts or monosaccharides to make the solution isotonic with blood. For buccal or sublingual administration the compositions may be administered in the form of tablets or lozenges which can be formulated in a conventional manner.

The delivery of one or more therapeutic genes by a vector system according to the invention may be used alone or in combination with other treatments or components of the treatment. Diseases which may be treated include, but are not limited to: cancer, neurological diseases, inherited diseases, heart disease, stroke, arthritis, viral infections and diseases of the immune system. Suitable therapeutic genes include those coding for tumour suppressor proteins, enzymes, pro-drug activating enzymes, immunomodulatory molecules, antibodies, engineered immunoglobulin-like molecules, fusion proteins, hormones, membrane proteins, vasoactive proteins or peptides, cytokines, chemokines, anti-viral proteins, antisense RNA and ribozymes.

In a preferred embodiment of a method of treatment according to the invention, a gene encoding a pro-drug activating enzyme is delivered to a tumour using the vector system of the invention and the individual is subsequently treated with an appropriate pro-drug. Examples of pro-drugs include etoposide phosphate (used with alkaline phosphatase Senter et al., 1988 Proc. Natl. Acad. Sci. 85: 4842-4846); 5-fluorocytosine (with Cytosine deaminase Mullen et al. 1994 Cancer Res. 54: 1503-1506); Doxorubicin-N-p-hydroxyphenoxyacetamide (with Penicillin-V-Amidase (Kerr et al. 1990 Cancer Immunol. Immunother. 31: 202-206); Para-N-bis(2-chloroethyl) aminobenzoyl glutamate (with Carboxypeptidase G2); Cephalosporin nitrogen mustard carbamates (with b-lactamase); SR4233 (with P450 Reducase); Ganciclovir (with HSV thymidine kinase, Borrelli et al. 1988 Proc Natl. Acad. Sci. 85: 7572-7576) mustard pro-drugs with nitroreductase (Friedlos et al. 1997J Med Chem 40: 1270-1275) and Cyclophosphamide or Ifosfamide (with a cytochrome P450 Chen et al. 1996 Cancer Res 56: 1331-1340).

According to a twelfth aspect of the present invention there is provided use of a retroviral vector, or retroviral particle, or cell in accordance with the present invention for use in enhancing transduction efficiency.

According to an thirteenth aspect of the present invention there is provided use of a retroviral vector, or retroviral particle, or cell in accordance with the present invention for use in altering the transduction ability of the vector. For example, the vector of the present invention may have the ability to transduce non-dividing cells unlike its wild type counterpart.

According to a fourteenth aspect of the present invention there is provided use of a retroviral vector, or retroviral particle, or cell in accordance with the present invention for use in promoting plus strand synthesis.

According to a fifteenth aspect of the present invention there is provided use of a retroviral vector, or retroviral particle, or cell in accordance with the present invention for use in increasing vector titre.

According to an sixteenth aspect of the present invention there is provided use of a retroviral vector, or retroviral particle, or cell in accordance with the present invention for the manufacture of a pharmaceutical composition to deliver an NOI to a target site in need of the same.

According to a seventeenth aspect of the present invention there is provided a method comprising transfecting or transducing a cell with a retroviral vector, or retroviral particle, or by use of a cell according to the present invention.

According to a eighteenth aspect of the present invention there is provided a delivery system in the form of a retroviral vector, or retroviral particle, or a cell according to the present invention.

According to a nineteenth aspect of the present invention there is provided a delivery system for a retroviral vector or retroviral particle, or a cell according to the present invention wherein the delivery system comprises a non-retroviral expression vector, an adenovirus and/or a plasmid.

The vector of the present invention may be a delivered to a target site by a viral or a non-viral vector.

As it is well known in the art, a vector is a tool that allows or faciliates the transfer of an entity from one environment to another. By way of example, some vectors used in recombinant DNA techniques allow entities, such as a segment of DNA (such as a heterologous DNA segment, such as a heterologous cDNA segment), to be transferred into a target cell. Optionally, once within the target cell, the vector may then serve to maintain the heterologous DNA within the cell or may act as a unit of DNA replication. Examples of vectors used in recombinant DNA techniques include plasmids, chromosomes, artificial chromosomes or viruses.

Non-viral delivery systems include but are not limited to DNA transfection methods. Here, transfection includes a process using a non-viral vector to deliver a gene to a target mammalian cell.

Typical transfection methods include electroporation, DNA biolistics, lipid-mediated transfection, compacted DNA-mediated transfection, liposomes, immunoliposomes, lipofectin, cationic agent-mediated, cationic facial amphiphiles (CFAs) (Nature Biotechnology 1996 14; 556), and combinations thereof.

Viral delivery systems include but are not limited to adenovirus vector, an adeno-associated viral (AAV) vector, a herpes viral vector, retroviral vector, lentiviral vector, baculoviral vector. Other examples of vectors include ex vivo delivery systems, which include but are not limited to DNA transfection methods such as electroporation, DNA biolistics, lipid-mediated transfection, compacted DNA-mediated transfection.

In accordance with the invention, standard molecular biology techniques may be used which are within the level of skill in the art. Such techniques are fully described in the literature. See for example; Sambrook et al (1989) Molecular Cloning; a laboratory manual; Hames and Glover (1985-1997) DNA Cloning: a practical approach, Volumes I-IV (second edition).

The invention will now be further described by way of example in which reference is made to the following Figures:

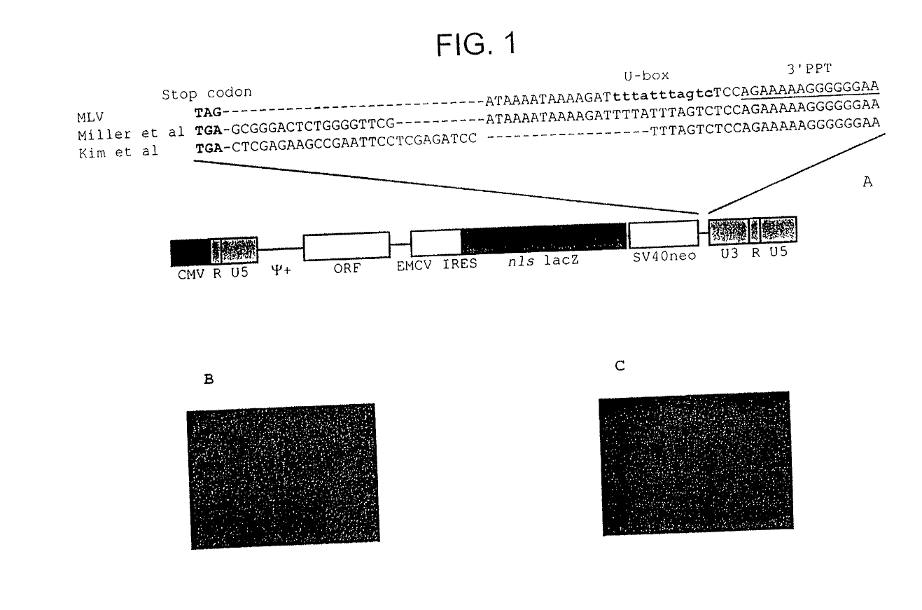

FIG. 1 shows the effect on titre of removal of flanking PPT sequence from an MLV-based expression cassette; and

FIG. 2 shows examples of plus strand synthesis elements which may be used in the present invention; and an example of degenerate elements.

In more detail:

FIG. 1A: the effect on titre of removal of flanking PPT sequence from an MLV-based expression cassette—the sequence alignments compare the variation between wild-type MLV provirus and two derived expression vectors. In the provirus, the stop codon (shown in bold) stops translation of envelope; in the expression vectors it stops translation of neo. For provirus sequence the putative U-box is shown in lower case bold and the 3′PPT is underlined. Virus production and X-gal staining was carried out as described previously (Soneoka et al 1995). FIGS. 1B and C show that inclusion of thew flanking PPT sequence greatly enhances (by approximately 100 fold) the titre of MLV based expression vectors. FIGS. 1B and C are photograpahs at 10⁻¹ viral dilution, of the X-gal stained cell layer. FIG. 1B shows an expression vectors containing 3′ sequence from Miller et al; titres rountinely at 500,000 to 1,000,000 per ml. FIG. 1C shows an expression vector containing 3′ sequences from Kim et al; titre rountinely at 5,000 to 10,000 per ml.

FIG. 2A shows F-PPT/3′PPT element which may be used in the present invention (F-PPT sequence in lower case; 3′PPT in upper case). FIG. 2B shows C-PPT elements which may be used in the present invention (F-PPT sequence in lower case; 3′PPT in upper case). FIG. 2C shows CTS elements which may be used in the present invention (HIV has three termination signals t0, t1 and t3). FIG. 2D shows an example of degenerate elements which can be used in evolution studies—for example, by construction of proviral libraries containing such a degenerate PPT sequence either inaddition to, or replacement of wild-type PPT sequence, subsequent passage of such proviral libraries on appropriate cells then analysis of the selected virus.

The inclusion of plus strand synthesis elements into retroviral expression vectors:

We have demonstrated (see Example 1 below) that plus strand synthesis elements such as the F-PPT region are important for the function of retroviral expression vectors and that the introduction of such sequence into expression vectors, including minimal vectors, such a pMOI can enhance the function of such vectors.

Optimisation of PPT/second strand synthesis function in retroviral based vectors:

We have demonstrated the impact F-PPT alterations have on retroviral expression vector function. It indicates that this F-PPT meditated effect is important for optimal vector function. F-PPT function is likely related to the functioning of the PPT element itself. This element, like that of the c-PPT and CTS is involved in second strand synthesis. Therefore such elements either in combination or singularly may determine vector function in at least some retroviral expression cassettes. Also such elements may be exquisitely sensitive to change. We also teach optimisation of F-PPT and the above mentioned related elements (3′PPT, c-PPT and CTS). This has been overlooked in previous vector design. It will therefore be appreciated that any retroviral expression vector with modified or additional second strand synthesis elements placed within the vector genome may enhance vector function.

Identification and inclusion of optimal second strand synthesis elements into lentiviral vectors:

Unlike oncoretroviruses, wild-type lentiviruses often possess two PPT sequences; a central PPT (c-PPT) and a 3′PPT. These sequences are often located within viral protein open reading frames (ORFs). For HIV, the c-PPT is located within the intergrase ORF and the 3′PPT located within NEF. Because of such locations, lentiviral PPT sequences can be said to have dual-function; serving both as protein coding sequence and cis-acting elements in second strand synthesis. As a consequence of this dual-function, such sequence elements may not be of optimal composition but instead constrained by the ORF in which they are located. As a consequence second-strand synthesis may not be optimal. Such a possibility therefore allows particular scope for the optimisation of such elements in lentiviral vectors because all proteins are now supplied in trans and thus constraints on the coding sequence of vector genome PPT and related second strand synthesis elements relaxed. Such optimisation may be achieved by the replacement of existing second strand synthesis elements (3′PPT, c-PPT, F-PPT, U-box and CTS sequences) or by the inclusion of additional elements into the viral expression vector. Indeed optimal vector second-strand synthesis might be achieved by inclusion of multiple origins of second-strand synthesis rather than just the two as is the case in proviruses or just the one (the 3′PPT) as is the case for many lentiviral derived expression vectors (for example see Zufferey et al 1997; Kim et at B 1998).

Inclusion of plus strand synthesis elements into retroviral based vectors to aid in the transduction of non-dividing cells:

Whilst oncoretroviruses and oncoretroviral derived vectors require cell division for successful transduction their lentiviral equivalents can also transduce non-dividing cells (Naldini et al 1996). To date the reason for this difference has remained elusive. One variable between these two types of virus is that for many members of the lentivirus family there has now been identified two origins of second strand synthesis; one from the c-PPT and one from the 3′PPT (for example see Blum et at 1986, Charneau et at 1994). For the oncoretroviruses there exists only one; the 3′PPT. Another difference, and related to the first is that lentiviruses, but not oncoretroviruses, also posses a defined central termination sequence (CTS); this sequence is also involved in effective second strand synthesis.

We have demonstrated the major effect that PPT related sequence elements have on vector function. We therefore propose that variations in second strand synthesis also account for variations in transducing ability between different retroviral vectors. In particular by the modification of second strand synthesis parameters in oncoretroviral based vectors one may confer on them an ability to transduce non-dividing cells. Furthermore by similar modification of second strand synthesis parameters in lentiviral based vector non-dividing cell transduction efficiency may be enhanced. Parameter alterations include, but are not limited to, the creation of multiple origins of second strand synthesis in oncoretroviral and lentiviral based vectors. For example, by the placing of additional F-PPT/PPT sequence elements into either MLV or HIV derived vector genomes and the inclusion of appropriate CTS elements if required.

Inclusion of pol based modification to enhance second strand synthesis:

We have demonstrated the importance of the inclusion of optimal second-strand synthesis cis acting elements into retroviral expression vectors for optimal vector function. Second strand synthesis may be an important, and overlooked parameter limiting vector function and titre. By the modification of such cis acting elements that promote effective second strand synthesis and by the inclusion, addition or replacement of such elements with those that perform optimally, vector function may be enhanced. This is however not the only method by which second-strand synthesis might be optimised. An additional method is by modification of the retroviral pol gene. This gene encodes enzymatic protein products (Reverse-transcriptase, RNaseH and Intergrase) that are essential for the reverse transcription and thus the second strand synthesis process. Introduction of optimal PPT sequence from either the related provirus or of non-self origin into a retroviral vector genome may therefore also require alteration of part or all of the viral pol gene expression cassette (normally included as a larger gag/pol expression cassette) used for in trans supply of the viral proteins required for effective packaging and delivery of vector genome. For example introduction of oncoretroviral PPT sequence into lentiviral expression vectors may also require similar inclusion or replacement of oncoretroviral based pot sequence into the pol expression cassette. Based on our observation of the importance of second strand synthesis for optimal vector function such synthesis may also be enhanced by modification of the trans acting proteins that interact with the any of the cis acting elements required for second strand synthesis. We therefore include such modifications designed to enhance such interactions and subsequent second strand synthesis.

### EXAMPLE 1

We used oncoretrovirus derived expression vectors based on two published vector backbone; pLXSN (Miller et al 1989) and pMOI (Kim et al B 1998). The pMOI vector has significantly less virally derived sequence flanking both the 5′ and 3′ LTR to that of pLXSN and thus can be considered more “minimal”. Specifically pMOI lacks all gag coding sequence at the 5′ of the vector and has no 3′ UTR (untranslated) sequence between env and the 3′ PPT.

We investigated the use of both pLXSN and pMOI vectors as potential candidates for the delivery of genes in gene therapy protocols. Interestingly when the same expression cassette (p450IRESlacZ-Sv40Neo) was placed in both vectors, it was discovered that the pLXSN vector out performed pMOI by one hundred fold on titre (see FIG. 1). Initially this observation was ascribed to the lack of gag sequence within the packaging signal (as previously reported; see Bender et al 1987); however on inclusion of this extra gag-based packaging signal into pMOI titre was not restored to pLXSN-levels. This result was surprising because both vectors now contained all known functional elements for optimal vector function.

A sequence comparison between these two vectors revealed that the only remaining differences (apart form plasmid backbone) were now located at the 3′ end of the vector in viral sequence upstream of the 3′PPT. For this reason it was concluded that presence of this viral sequence—located between env and the 3′PPT in the MLV provirus—must account for the increased performance of the pLXSN based vectors. To confirm this conclusion the 3′ sequence of the pLXSN-based vector was replaced by the 3′ sequence of the pMOI and the two, now subtly (18 base pairs, see FIG. 1), different vectors compared. As postulated the pLXSN based vector outperformed the pLXSN-3′pMOI by approximately 100 fold (see FIG. 1).

These observations have lead us to consider that there exist previously unrecognised functional regions in retroviral expression vectors that flank the 3′PPT. We term these regions the flanking PPT (F-PPT) and have demonstrated that they are essential for efficient function of retroviral expression vectors. This is the first time that this region has been shown important for any retroviral based vector. Interestingly this region partially overlaps the sequence in MLV previously aligned to the U-box in SIV (Llyinskii and Desrosiers 1998). Although of unknown function, this U-box has recently been shown important in SIV proviral replication and like the 3′PPT, the c-PPT and the CTS it has been suggested to be a sequence element involved in RT mediated second strand initiation/synthesis (Llyinskii and Desrosiers 1998)

### EXAMPLE 2

### Inclusion of the Central PPT and Central Termination Sequences in Lentivectors

As has been previously discussed it is possible to optimise the performance of lentiviral vectors by the inclusion of cis-acting sequences involved in second strand synthesis, such as the cis-acting sequences of the central polypurine tract (cPPT) and central termination sequence (CTS). Such a sequence is that described by Stetor et al.(1999) for EIAV and corresponds to nucleotides 4916-5039 of the EIAV genome Genbank Accession Number U01866.

This sequence and small amounts of flanking residue were amplified from an EIAV proviral clone using primers containing the sequences for the enzymes SalI and XbaI, which are unique in the EIAV vector, pONY4.0. The vector pONY4.0 is described in our WO99132646. The amplified sequence was as follows:

CAGGTTATTCTAGAGTCGACGCTCTCATTACTTGTAACAAAGGGAGGGAA AGTATGGGAGGACAGACACCATGGGAAGTATTTATCACTAATCAAGCA CAAGTAATACATGAGAAACTTTTACTACAGCAAGCACAATCCTCCAAA AAATTTTGTTTTTACAAAATCCCTGGTGAACATGGTCGACTCTAGAACGCA TTCG

XbaI site is underlined and the SalI in italic. The functionally active sequence (4916-5039) is in bold and includes elements referred to as the central PPT and the CTS. By utilising the XbaI site the element may be placed upstream of the internal CMV promoter. Using the SalI site it can be placed downstream of the LacZ gene in pONY4.0.

Vector preparations incorporating these modifications is made by cotransfection of the plasmids encoding the modified pONY4.0 vectors together with gag/pol and VSV-G expression plasmids into 293T cell line using standard techniques.

An analogous modification to HIV vectors is made as follows.

The cPPT/TCS sequence shown below is created by PCR and is taken from the HIV genome (strain HXB2 4771-4926nt, Genbank Accession Number M38432) and represents the central PPT and CTS as delineated by Charneau et al (1994).

CATCCACAATTTTAAAAGAAAAGGGGGGATTGGGGGGTACAGTGCAGGGG AAAGAATAGTAGACATAATAGCAACAGACATACAAACTAAAGAATTACAA AAACAAATTACAAAAATTCAAAATTTTCGGGTTTATTACAGGGACAGCAG AAATTC

The cPPT is underlined and the CTS is shown in bold and underlined.

The PCR product is then inserted into the Msc I site of pH4Z (Kim et al., A 1998) to make pH4ZcPPT.

TABLE 1
Classification of Retroviruses

| Genus | | Example |
|---|---|---|
| 1. | Avian sarcoma and | Rous sarcoma virus |
| | leukosis viral group | |
| 2. | Mammalian B-type | mouse mammary |
| | viral group | tumor virus |
| 3. | Murine leukemia- | Maloney murine |
| | related viral group | leukemia virus |
| 4. | Human T-cell leukemia- | human T-cell |
| | bovine leukemia viral | leukemia virus |
| | group | |
| 5. | D-type viral | Mason-Pfizer |
| | group | monkey virus |
| 6. | Lentiviruses | human immuno- |
| | | deficiency virus |
| 7. | Spumaviruses | human foamy virus |

TABLE 2
Principal Retroviruses and Their Origins

| Virus | Abbreviation |
|---|---|
| Simple Retroviruses | |
| Avian leukosis virus | ALV |
| Rous sarcoma virus | RSV |
| Rous-associated virus | RAV |
| Fujinami sarcoma virus | FuSV |
| Avian myelocytoma virus MH2 | MH2 |
| Avian erythroblastosis virus | AEV |
| S13 avian erythroblastosis virus | |
| Avian myeloblastosis virus | AMV |
| Avian retrovirus RPL 12 | |
| CT10 avian sarcoma virus | CT10 |
| Avian myeloblastosis- | |
| erythoblastosis virus E26 | E26 |
| Avian myelocytoma MC29 | MC29 |
| Avian retrovirus RPL30 | |
| Rous-associated virus-0 | RAV-0 |
| Avian sarcoma virus | UR2 |
| Avian retrovirus | SKV |
| Y73 avian sarcoma virus | Y73 |
| Avian sarcoma virus 17 | |
| Avian retrovirus AS42 | ASV42 |
| Avian retrovirus | ASV31 |
| Mouse mammary tumor virus | MMTV |
| Gross murine leukemia virus | Gross MLV |
| Graffi murine leukemia virus | Graffi MLV |
| Friend murine leukemia virus | Fr-MLV |
| Radiation leukemia virus | RadLV |
| Spleen necrosis virus | SNV |
| Moloney murine leukemia virus | Mo-MLV |
| Harvey murine sarcoma virus | Ha-MSV |
| Feline leukemia virus | FeLV |
| Spleen focus-forming virus | SFFV |
| Finkel-Biskis-Jinkins murine | FB-MSV |
| sarcoma virus | |
| Moloney murine sarcoma virus | Mo-MSV |
| Avian reticuloendotheliosis virus | REV |
| Kirsten murine sarcoma virus | Ki-MSV |
| Baboon endogenous virus | BaEV |
| Abelson murine leukemia virus | Ab-MLV |
| Gibbon ape leukemia virus | GALV |
| Gardner-Arnstein feline sarcoma | GA-FeSV |
| virus | |
| McDonough feline sarcoma virus | SM-FeSV |
| Simian sarcoma virus | SSV |
| Snyder-Theilen feline sarcoma | ST-FeSV |
| virus | |
| Murine sarcoma virus 3611 | MSV3611 |
| Hardy-Zuckerman feline sarcoma | HZ4FeSV |
| virus | |
| Mouse myeloproliferative | |
| leukemia virus | |
| Mason-Pfizer monkey-type virus | MPMV |
| Jaagsiekte virus | |
| Complex Retroviruses | |
| Bovine leukemia virus | BLV |
| Human T-cell leukemia virus-1 | HTLV-1 |
| Human T-cell leukemia virus-2 | HTLV-2 |
| Equine infectious anemia virus | EIAV |
| Visnavirus | |
| Caprine arthritis-encephalitis | CAEV |
| virus | |
| Bovine immunodeficiency virus | BIV |
| Human immunodeficiency | HIV-1 |
| virus-1 | |
| Simian immunodeficiency virus | SIV |
| Human immunodeficiency | HIV-2 |
| virus-2 | |
| Feline immunodeficiency virus | FIV |
| Human foamy virus | HFV |
| Simian foamy virus | SFV |
| Walleye dermal sarcoma virus | WDSV |

TABLE 3
LENTIVIRUSES

Nucleic acid database

| | Locus names | acc.no. |
|---|---|---|
| HIV-1 | HIVHXB2CG | K03455 |
| | HIVNL43 | M19921 |
| | HIVBRUCG | K02013 |
| | HIVNY5CG | M38431 |
| | HIVJRCCSF | M38429 |
| | HIVSF2CG | K02007 |
| | HIVMNCG | M17449 |
| HIV-2 | HIV2BEN | M30502 |
| | HIV2D194 | J04542 |
| | HIV2GHI | M30895 |
| | HIV2ISY | J04498 |
| | HIV2ROD | M15390 |
| | HIV2ST | M31113 |
| | HIV2UC1GNM | L07625 |
| SIV | SIVAGM155 | M29975 |
| | SIVAGM3 | M30931 |
| | SIVAGM677A | M58410 |
| | SIVAGMAA | M66437 |
| | SIVCOMGNM | L06042 |
| | SIVMM239 | M33262 |
| | SIVMM251 | M19499 |
| | SIVMNE | M32741 |
| | SIVSMMPBJA | M31345 |
| | SIVSMMPBJB | L03295 |
| FIV | FIVCG | M25381 |
| | FIVPPR | M36968 |
| | F1U11820 | U11820 |
| BIV | B1M127 | M32690 |
| EIAV | EIAVCG | M16575 |
| | EIAGGIP | M87581 |
| | EIU01866 | U01866 |
| Visna | VLVCG | M10608 |
| | VLVCGA | M51543 |
| | VLVGAGA | L06906 |
| | VLVLV1A | M60609 |
| | VLVLV1B | M60610 |
| CAEV | CAEVCG | M33677 |
| Ovine Lentivirus | OLVCG | M31646 |
| | OLVSAOMVCG | M34193 |

1. A plus-strand synthesis element comprising a flanking polypurine tract (F-PPT) or derivative, variant or homologue thereof.

2. Use of a retroviral plus-strand synthesis element for altering transduction ability of a retroviral vector or retroviral vector particle.

3. Use of a retroviral plus-strand synthesis element for increasing the titre of a retroviral vector.

4. A retroviral vector in which one or more accessory genes are absent characterised in that it comprises a plus-strand synthesis element.

5. A retroviral vector capable of delivering an NOI and comprising an exogenous second synthesis element.

6. Use or a retroviral vector according to any one of claims 2 to 5 wherein the plus-strand synthesis element is PPT, c-PPT, CTS, a U box or F-PPT, including derivatives, variants and homologues thereof.

7. Use or a retroviral vector according to any preceding claim wherein the vector is obtainable from a lentivirus genome.

8. A retroviral vector packaging cell or cell line, or a retroviral vector expression plasmid or cassette comprising an exogenous trans acting element.

9. A retroviral vector packaging cell or cell line, or a retroviral vector expression plasmid or cassette according to claim 8 wherein the trans acting element is pol.

10. A retroviral production system for producing the retroviral vector of any one of claims 4 to 7 comprising a nucleic acid sequence encoding for the retroviral vector.

11. A retroviral production system according to claim 10 further comprising the retroviral vector packaging cell or cell line, or a retroviral vector expression plasmid or cassette of claim 8 or 9.

12. A retroviral vector produced by the production system of claim 10 or 11.

13. A retroviral particle obtainable from the retroviral vector of any one of claims 4 to 7 or claim 12.

14. A cell transfected or transduced with a retroviral vector of any one of claims 4 to 7 or claim 12.

15. A retroviral vector, or retroviral particle, or cell in accordance with any one of claims 4 to 7 or 12 to 14 for use in medicine.

16. Use of a retroviral vector, or retroviral particle, or cell in accordance with any one of claims 4 to 7 or 12 to 14 for use in altering the transduction ability of the vector.

17. Use of a retroviral vector, or retroviral particle, or cell in accordance with any one of claims 4 to 7 or 12 to 14 for use in promoting plus strand synthesis.

18. Use of a retroviral vector, or retroviral particle, or cell in accordance with any one of claims 4 to 7 or 12 to 14 for use in increasing vector titre.

19. A pharmaceutical composition comprising a retroviral vector, or retroviral particle, or cell in accordance with any one of claims 4 to 7 or 12 to 14 and a pharmaceutically acceptable excipient, diluent or carrier.

20. Use of a retroviral vector, or retroviral particle, or cell in accordance with any one of claims 4 to 7 or 12 to 14 for the manufacture of a pharmaceutical composition to deliver an NOI to a target site in need of the same.

21. A method comprising transfecting or transducing a cell with a retroviral vector, or retroviral particle, or by use of a cell according to any one of claims 4 to 7 or 12 to 14.

22. A delivery system in the form of a retroviral vector, or retroviral particle, or a cell according to any one of claims 4 to 7 or 12 to 14.

23. A delivery system for a retroviral vector or retroviral particle, or a cell according any one of claims 4 to 7 or 12 to 14 wherein the delivery system comprises a non-retroviral expression vector, an adenovirus and/or a plasmid.


SEQUENCE LISTING (31 sequences)

SEQ ID NO: 1 - DNA, 18 bp, Murine leukemia virus
ataaaataaaagatttta

SEQ ID NO: 2 - DNA, 32 bp, Equine infectious anemia virus
cacatctcatgtatcaatgcctcagtatgttt

SEQ ID NO: 3 - DNA, 37 bp, Human Immunodeficiency Virus Type 1
tgacttacaaggcagctgtagatcttagccacttttt

SEQ ID NO: 4 - DNA, 39 bp, Simian immunodeficiency virus
aatgacttataaacttgcagcggatttttcgcacttttt

SEQ ID NO: 5 - DNA, 36 bp, Rous sarcoma virus
gacagctatttgtaactgcgaaatacgcttttgcat

SEQ ID NO: 6 - DNA, 30 bp, Murine leukemia virus
ataaaataaaagattttatttagtctccac

SEQ ID NO: 7 - DNA, 29 bp, Human Immunodeficiency Virus Type 1
tacaaatggcagtattcatccacaatttt

SEQ ID NO: 8 - DNA, 15 bp, Murine leukemia virus
agaaaaaggggggaa

SEQ ID NO: 9 - DNA, 18 bp, Equine infectious anemia virus
agaaaaacaaggggggaa

SEQ ID NO: 10 - DNA, 16 bp, Human Immunodeficiency Virus Type 1
aaaagaaaagggggga

SEQ ID NO: 11 - DNA, 16 bp, Simian immunodeficiency virus
aaaagaaaagggagga

SEQ ID NO: 12 - DNA, 13 bp, Rous sarcoma virus
agggagggggaaa

SEQ ID NO: 13 - DNA, 13 bp, Murine leukemia virus
aaaaaggggggaa

SEQ ID NO: 14 - DNA, 23 bp, Human Immunodeficiency Virus Type 1
aaaagaaaaggggggatgggggg

SEQ ID NO: 15 - DNA, 59 bp, Human Immunodeficiency Virus Type 1
  misc_feature (1)..(59): central termination sequence (CTS) sequence of HIV-1
tacaaactaaagaattacaaaaacaaattacaaaaattcaaaattttcggggtttatta

SEQ ID NO: 16 - DNA, 124 bp, Equine infectious anemia virus
aacaaagggagggaaactatgggaggacagacaccatgggaagtatttatcactaatcaagcacaagtaatacatgagaaacttttactacagcaagcacaatcctccaaaaaattttgttttt

SEQ ID NO: 17 - DNA, 15 bp, Human immunodeficiency virus
  misc_feature (1)..(15): central polypurine tract (c-PPT) sequence
aaaagaaaagggggg

SEQ ID NO: 18 - DNA, 29 bp, Human immunodeficiency virus
  misc_feature (1)..(29): central termination sequence (CTS)
aaaaacaaattacaaaaattcaaaatttt

SEQ ID NO: 19 - DNA, 201 bp, Artificial Sequence
  sequence of PCR product showing cis-acting sequences of c-PPT and CTS involved in second strand synthesis and flanking residue
caggttattctagagtcgacgctctcattacttgtaacaaagggagggaaagtatgggaggacagacaccatgggaagtatttatcactaatcaagcacaagtaatacatgagaaacttttactacagcaagcacaatcctccaaaaaattttgtttttacaaaatccctggtgaacatggtcgactctagaacgcattcg

SEQ ID NO: 20 - DNA, 156 bp, Artificial Sequence
  sequence of PCR product containing the central polypurine tract (cPPT) and central terminal sequence (CTS
catccacaattttaaaagaaaaggggggattggggggtacagtgcaggggaaagaatagtagacataatagcaacagacatacaaactaaagaattacaaaaacaaattacaaaaattcaaaattttcgggtttattacagggacagcagaaattc

SEQ ID NO: 21 - DNA, 46 bp, Murine leukemia virus
tgaataaaataaaagattttatttagtctccagaaaaaggggggaa

SEQ ID NO: 22 - DNA, 64 bp, Artificial Sequence
  Vector sequence
tgagcgggactctggggttcgataaaataaaagattttatttagtctccagaaaaaggggggaa

SEQ ID NO: 23 - DNA, 55 bp, Artificial Sequence
  Vector sequence
tgactcgagaagccgaattcctcgagatcctttagtctccagaaaaaggggggaa

SEQ ID NO: 24 - DNA, 50 bp, Equine infectious anemia virus
cacatctcatgtatcaatgcctcagtatgtttagaaaaacaaggggggaa

SEQ ID NO: 25 - DNA, 53 bp, Human Immunodeficiency Virus Type 1
tgacttacaaggcagctgtagatcttagccactttttaaaagaaaagggggga

SEQ ID NO: 26 - DNA, 55 bp, Simian Immunodeficiency Virus
aatgacttataaacttgcagcggatttttcgcactttttaaaagaaaagggggga

SEQ ID NO: 27 - DNA, 49 bp, Rous sarcoma virus
gacagctatttgtaactgcgaaatacgcttttgcatagggagggggaaa

SEQ ID NO: 28 - DNA, 43 bp, Murine leukemia virus
ataaaataaaagattttatttagtctccacaaaaaggggggaa

SEQ ID NO: 29 - DNA, 52 bp, Human Immunodeficiency Virus Type 1
tacaaatggcagtattcatccacaattttaaaagaaaaggggggatgggggg

SEQ ID NO: 30 - DNA, 59 bp, Human Immunodeficiency Virus Type 1; identical to SEQ ID NO: 15

SEQ ID NO: 31 - DNA, 40 bp, Artificial Sequence
  degenerate polypurine tract  (PPT)  sequence
nnnnnnnnnnnnnnnnnnnnnnnnnnnnnnnnnnnnnnag